(19) United States
(12) Patent Application Publication
(10) Pub. No.: US 2019/0157817 A1
(43) Pub. Date: May 23, 2019

(54) SMART RECEPTACLE HAVING PLUG BLADE DETECTION

(71) Applicant: Grid Connect, Inc., Naperville, IL (US)

(72) Inventor: Cristian Codreanu, Naperville, IL (US)

(73) Assignee: Grid Connect, Inc., Naperville, IL (US)

(21) Appl. No.: 15/816,671

(22) Filed: Nov. 17, 2017

(51) Int. Cl. H01R 13/713; H01R 13/652; H01R 13/66; H01R 13/71; H01R 24/78

(52) U.S. Cl. CPC H01R 13/7137; H01R 13/652; H01R 24/78; H01R 13/71; H01R 13/6691

(57) ABSTRACT

An electrical outlet is disclosed. The outlet includes a power receptacle configured to receive a plug blade and a switch. The switch has a first state when the plug blade is not present within the power receptacle, and a second state when the plug blade is present. The plug blade provides an electrically conductive path between terminals of the switch in the second state. A pulse generator circuit is configured to generate a pulsed signal having a frequency higher than a frequency of alternating current voltage power. A feedback circuit receives the pulsed signal from the pulse generator circuit and provides an output signal to a pulse detection circuit. The output signal includes a pulsed signal corresponding to the pulsed signal received from the pulse generator circuit when the switch is in the first state and a generally continuous state signal when the switch is in the second state.

### BACKGROUND

Various electrical receptacles are available in which a detection switch is incorporated in the receptacle to detect the presence of a properly inserted plug connector. Usually, the receptacle does not receive current unless the detection switch is actuated. Such systems might be used as a simple safety measure. For instance, the detection switch might be used to detect the presence of a ground terminal of a three-pronged plug. If a two-pronged plug is inserted into the receptacle, the switch will not be actuated and no current will be supplied to the receptacle unless a proper three-pronged plug is inserted, whereupon the ground terminal actuates the detection switch.

In certain “smart” power receptacles, it may be desirable to prevent supply power from reaching the receptacle unless a power plug is inserted. The detection switch might be actuated by any one of the prongs or blades of the power receptacle, at which point the detection switch is actuated to tell a controller to send power to the receptacle.

In some detection switches, the contacts of the switches are deflected indirectly by a terminal prong or blade through a separator made of an insulating material. This is particularly useful in a power receptacle since the detection switch is usually a low voltage switch. The insulator provides electrical isolation between the low voltage circuit and the higher voltage circuit of the power receptacle.

One of the problems with electrical receptacles that embody such detection switches is that the receptacles may be unduly complicated or require excessive mechanical components to ensure that the detection switch provides a detection signal for use by a controller. Such receptacles frequently are not cost effective because of assembly procedures involved in assembling the detection switch within an otherwise simple electrical receptacle.

### SUMMARY

One general aspect of the disclosure is directed an outlet for providing an alternating current voltage to a power plug. The outlet includes a power receptacle configured to receive a plug blade of the power plug and a switch having a first state when the plug blade is not present within the power receptacle, and a second state when the plug blade is present within the power receptacle, where the plug blade provides an electrically conductive path between terminals of the switch in the second state. The outlet also includes a pulse generator circuit configured to generate a pulsed signal having a frequency higher than a frequency of the alternating current voltage. The outlet also includes a feedback circuit configured to receive the pulsed signal from the pulse generator circuit. The feedback circuit provides an output signal to a pulse detection circuit. The output signal includes a pulsed signal corresponding to the pulsed signal received from the pulse generator circuit when the switch is in the first state and a generally continuous state signal when the switch is in the second state.

In various implementations: the feedback circuit includes a logic level converter circuit providing the pulsed signal to the pulse detection circuit; the pulse generator circuit includes a microcontroller coupled to an input of the feedback circuit, where the feedback circuit includes a logic level converter circuit configured to provide the pulsed signal to the pulse detector circuit; the pulse detection circuit includes a microcontroller coupled to an output of the feedback circuit, and where the feedback circuit includes a logic level converter circuit providing the pulsed signal to the pulse detector pulse detection; the microcontroller is configured to control execution of one or more smart outlet operations in response to a signal state with the output of the feedback circuit; the switch goes to the second state only when the plug blade is completely inserted into the power receptacle; a power relay circuit is configured to connect the power plug to the alternating current voltage under control of the microcontroller; the switch includes a first contact and a second contact, where the first and second contacts are electrically isolated from one another when the plug blade is not inserted into the power receptacle, and where the first and second contacts are electrically coupled through the plug blade when the plug blade is inserted into the power receptacle.

Another general aspect of the disclosure is also directed to an outlet for providing an alternating current voltage to a power plug. The outlet may include a power receptacle configured to receive a plug blade of the power plug. The power receptacle may have a first contact and a second contact, where the first and second contacts are electrically isolated from one another when the plug blade is not inserted into the power receptacle, and where the first and second contacts are electrically coupled through the plug blade when the plug blade is inserted into the power receptacle. The outlet may also include a pulse generator circuit configured to provide a pulsed signal to an output thereof, where the pulsed signal has a frequency greater than a frequency of the alternating current voltage. A pulse detection circuit configured to detect presence of a pulsed signal at an input thereof. A filter network may be configured to pass the pulsed signal from the output of the pulse generator circuit to the input of the pulse detection circuit when the first and second contacts are electrically isolated from one another. The filter network May the further configured to bypass the pulsed signal from the input of the pulse detection circuit when the first and second contacts are electrically connected to one another.

In various implementations: the filter network includes a high-pass filter electrically configured between the output of the pulse generator circuit and the input of the pulse detection circuit; the outlet may include a high-frequency bypass filter electrically configured between the second contact and the high-pass filter when the first and second contacts are electrically connected with one another; the filter network includes a logic level converter circuit configured to provide the pulsed signal to the pulse generator circuit; the pulse detection circuit includes a microcontroller coupled to an output of the filter network, and the microcontroller is configured to control execution of one or more smart outlet operations based on a state of the output of the filter network.

Another general aspect of the disclosure is also directed an outlet for providing an alternating current voltage to a power plug. The outlet includes a power receptacle configured to receive a plug blade of the power plug. The power receptacle may have a first contact and a second contact, where the first and second contacts are displaced from one another so that the first and second contacts are electrically isolated from one another when the plug blade is not inserted into the power receptacle, and the first and second contacts are electrically connected by the plug blade when the plug blade is inserted into the power receptacle. The outlet also may include a microcontroller configured to generate a pulsed signal at an output thereof, where the microcontroller is further configured to detect a pulsed signal at an input thereof. The pulsed signal has a frequency greater than a frequency of the alternating current voltage. The outlet also includes a feedback circuit. The feedback circuit may include a high-pass filter electrically configured between the output of the microcontroller and the second contact, a high-frequency bypass filter electrically configured between the first contact and ground, and a logic level converter circuit electrically coupled between the high-pass filter and the input of the microcontroller. The microcontroller may be configured to control execution of one or more smart outlet operations based on whether pulsed signals are provided to the input of the microcontroller.

### BRIEF DESCRIPTION OF THE DRAWINGS

FIG. 1 is a block diagram of a smart outlet that may provide alternating current power to an appliance or the like through a power plug.

FIG. 2 is a block diagram of one implementation of a smart outlet.

FIG. 3 illustrates waveforms of signals that may occur at various nodes in the exemplary smart outlet embodiment shown in FIG. 2.

FIGS. 4-6 show one way a plug detection switch may operate at a slot of a receptacle.

FIG. 7 illustrates one way the second terminal of the plug detection switch of FIGS. 4-6 may be constructed.

### DETAILED DESCRIPTION

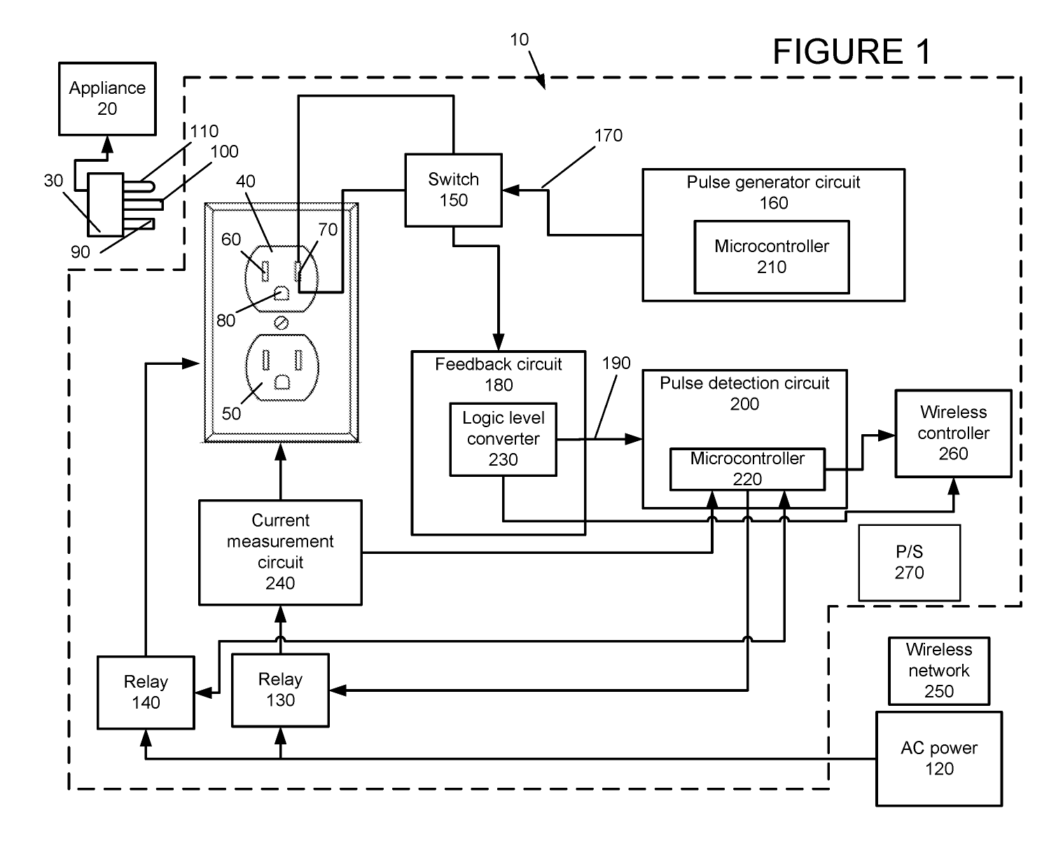

FIG. 1 is a block diagram of a smart outlet 10 that is configured to provide an alternating current voltage to an appliance 20 through a power plug 30. The smart outlet 10 may include one or more receptacles 40 and 50. For purposes of the following discussion, the operation of the smart outlet 10 will principally be directed to components associated with receptacle 40.

Receptacle 40 includes sockets 60 and 70 and a ground terminal 80 configured to receive plug blades 90 and 100 and ground plug 110 of the power plug 30. In operation, alternating current voltage is provided to the power plug 30 through receptacle 40 from the AC power source 120 through one or more relays 130 and 140. The AC power source 120 may be the powerlines of a home, a business, a generator, etc.

The smart outlet 10 detects the presence and absence of one or more of the plug blades 90, 100 within the respective sockets 60, 70 of the receptacle 40. For purposes of the following discussion, reference will principally be made to blade 90 and socket 70. Socket 70 may be configured to provide line power while socket 60 is configured as a neutral line.

To detect blade 90, the smart outlet 10 includes a plug detection switch 150 having a first state when plug blade 90 is not substantially inserted into or completely removed from socket 70. The switch 150 has a second state when the plug blade 90 is substantially inserted into socket 70. As will be explained in further detail below, the plug blade 90 provides an electrically conductive path between the terminals of the plug detection switch 150 in the second state.

The smart outlet 10 also includes a pulse generator circuit 160. The pulse generator circuit 160 generates a pulsed signal at output 170. The pulsed signal has a frequency that is higher than the frequency of the alternating current voltage provided by the AC power source 120 and, for example, a magnitude corresponding to a logic level signal. In one example, the pulsed signal may have a frequency of about 1 kHz. However, other frequencies that are readily removed by a high-pass filter from, for example, a 60 Hz line signal may also be employed.

A feedback circuit 180 is configured to receive the pulsed signal at output 170 from the pulse generator circuit 160. The feedback circuit 180 provides an output signal 190 having characteristics that are dependent on the state of plug detection switch 150. For example, the output signal may comprise a pulsed signal corresponding to the pulsed signal received from the pulse generator circuit 160 when the plug detection switch 150 is in the first state. The output signal may go to a generally constant, non-pulsed signal when the plug detection switch 150 is in the second state. The output of the feedback circuit 180 is provided to the input of a pulse detection circuit 200.

In one embodiment, the output 170 of the pulse generator circuit 160 includes a microcontroller 210 that is coupled to the input of the feedback circuit 180. To this end, the microcontroller 210 may be programmed to provide a pulsed signal at one or more of its pins. The pulsed signal from the microcontroller 210 may be provided directly to the feedback circuit 180 or through a buffer. The pulse detection circuit 200 may also include a microcontroller 220 coupled to an output of the feedback circuit 180. Although two distinct microcontrollers 210 and 220 are shown in the embodiment of FIG. 1, a single microcontroller may be used to implement both the pulse generator circuit 160 and the pulse detection circuit 200. In one example, the feedback circuit 180 provides the output signal 190 to the pulse detection circuit 200 using a logic level converter 230. The output signal 190 may be polled by the microcontroller 220, used to generate an interrupt at microcontroller 220, or other similar detection method.

In one example, the microcontroller 220 uses the state of the output signal 190 of the feedback circuit 180 to control execution of one or more smart outlet operations. Various components may be incorporated into the smart outlet 10 and operated either directly or indirectly by the microcontroller 220. For example, the microcontroller 220 may operate relay 140 to connect the AC power source 120 to the receptacle 40 when the plug blade 90 is substantially inserted into socket 70, and to disconnect the AC power source 120 from the receptacle 40 when the plug blade 90 is not substantially inserted into socket 70. The presence or absence of the plug blade 90 at socket 70, as detected by the microcontroller 220, may also be used to control relay 140 to thereby connect and disconnect the AC power source 120 to and from receptacle 50. In another example, the microcontroller 220 may measure the current flow of the AC voltage provided to the power plug 30 using, for example, a current measurement circuit 240.

In various embodiments, the output signal 190 of the feedback circuit 180 may be used to control communication between the smart outlet 10 and a wireless network 250. For example, the microcontroller 220 may establish a connection with the wireless network 250 in response to the state of the output signal 190 using, for example, a wireless controller 260. Once linked with the wireless network 250, the microcontroller 220 may receive commands and/or exchange data with the wireless network 250. Among other things, the smart outlet 10 may exchange and receive commands regarding one or more of: 1) whether a plug is inserted into one or both of receptacles 40 and 50; 2) whether relays 130 and/or 140 have been actuated to provide AC voltage to one or both receptacles 40 and 50; and/or 3) the value of the current measured by the current measurement circuit 240. The microcontroller 220 may also receive commands over the wireless network 250 directing the microcontroller 220 to execute operations irrespective of the state of the output signal 190. For example, the microcontroller 220 may receive commands to: 1) activate or deactivate one or both relays 130 and/or 140; or 2) take and transmit a measurement of the current through receptacles 40 and 50 as determined by the current measurement circuit 240. Additionally, or alternatively, the output signal 190 may be provided directly to the input of the wireless controller 260 which, in turn, establishes or otherwise uses its own independent link with the wireless network 250.

As shown in FIG. 1, the smart outlet 10 may include an on-board power supply 270 to provide power to its various components. The power supply 270 may be implemented in a variety of manners. In one embodiment, the power supply 270 may be connected to the AC power source 120 and convert the AC voltage to levels and conditions needed for operation of the various components. In another embodiment, the power supply 270 may be self-contained without connection to an external power source. In such instances, the power supply 270 may be implemented, for example, using a battery or the like. In a still further embodiment, the power supply 270 may be a hybrid including both a connection to the AC power source 120, a rechargeable battery, and a recharge circuit connected to the AC power source 120.

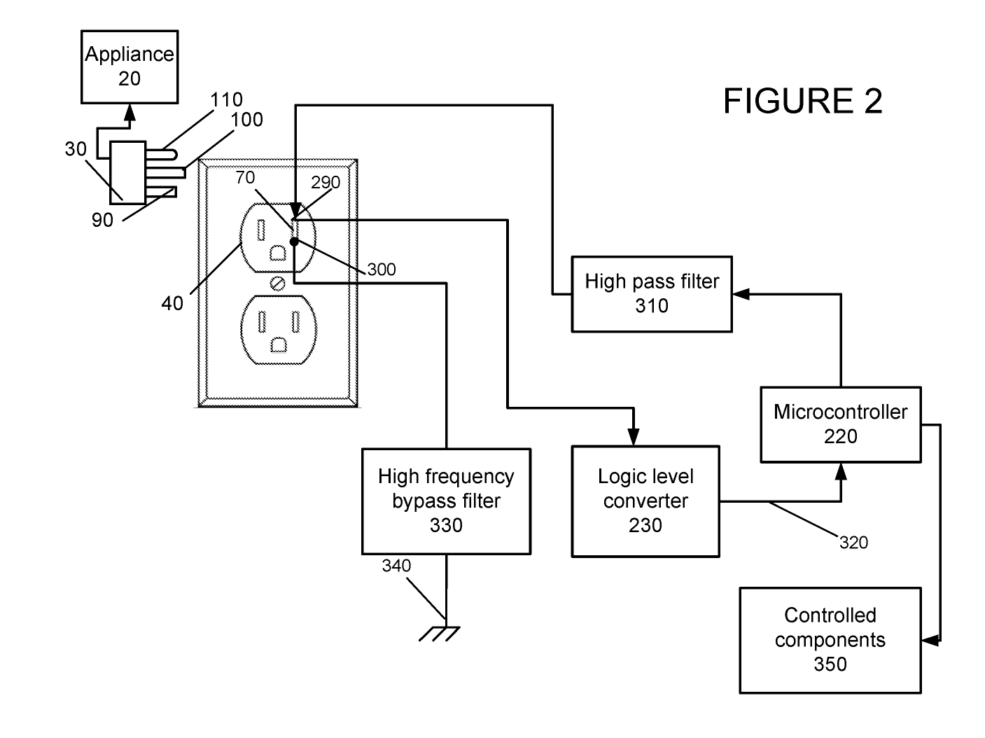

FIG. 2 illustrates another embodiment of the smart outlet 10. In this embodiment, socket 70 includes a first terminal 290 and a second terminal 300 that are electrically isolated from one another when the plug blade 90 is not present or otherwise not substantially inserted into the socket 70. As will be set forth below, the first and second terminals 290 and 300 may be spatially offset from one another so that a connection between the terminals is only established when the plug blade 90 is substantially or otherwise completely inserted into the socket 70.

The first terminal 290 receives a pulsed signal from the microcontroller 220 through a high-pass filter 310. The pulsed signal at first terminal 290 is provided to an input of the logic level converter 230. Absent the plug blade 90, the output 320 of the logic level converter 230 is a pulsed signal which is detected at microcontroller 220. When the plug blade 90 is substantially inserted into the socket 70, the first and second terminals 290 are electrically connected with one another through the conductive plug blade 90. In this state, the pulsed output of the high-pass filter 310 is directed through a high-frequency bypass filter 330, which bypasses the pulsed output to, for example, a ground terminal 340. This causes the signal at terminal 290 to go to a generally constant state causing the output of the logic level converter 230 to supply a constant level logic signal at output 320 to the microcontroller 220. In turn, the microcontroller 220 operates to control one or more controlled components 350 in response to the state of the signal at output 320.

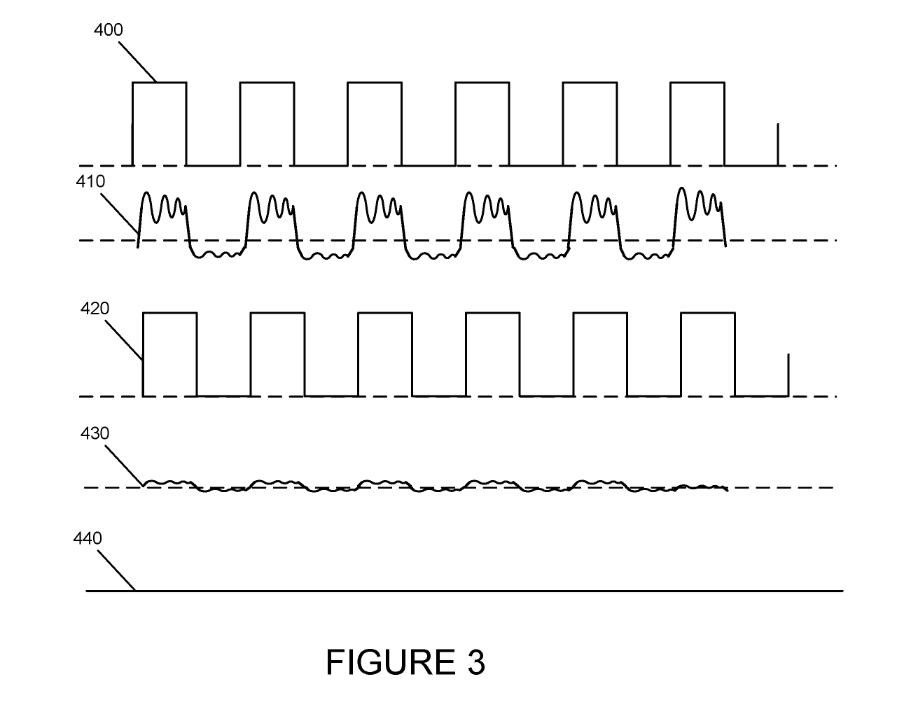

FIG. 3 illustrates waveforms occurring at various nodes in the exemplary smart receptacle embodiments shown in FIG. 1 and FIG. 2. In this example, waveform 400 represents the pulsed output signal generated by the microcontroller 220. Waveform 410 represents the pulsed signal after passing through the high-pass filter 310 to the first terminal 290. Absent the insertion of blade 90, the signal represented by waveform 410 is provided to the input of the logic level converter 230. The signal represented by waveform 410 periodically exceeds the logic transition threshold of the logic level converter 230 and thus results in a pulsed logic level signal 420 from the logic level converter 230 to the microcontroller 220. When the plug blade 90 is substantially inserted into the socket 70, the signal represented by waveform 410 is superimposed on the 60 Hz AC voltage and bypassed to ground through the high-frequency bypass filter 330 thereby providing a voltage waveform 430 to the logic level converter 230. Since the voltage waveform 430 has a voltage below the trigger voltage of the logic level converter 230, the logic level converter 230 provides a signal 440 having a constant logic level to the microcontroller 220.

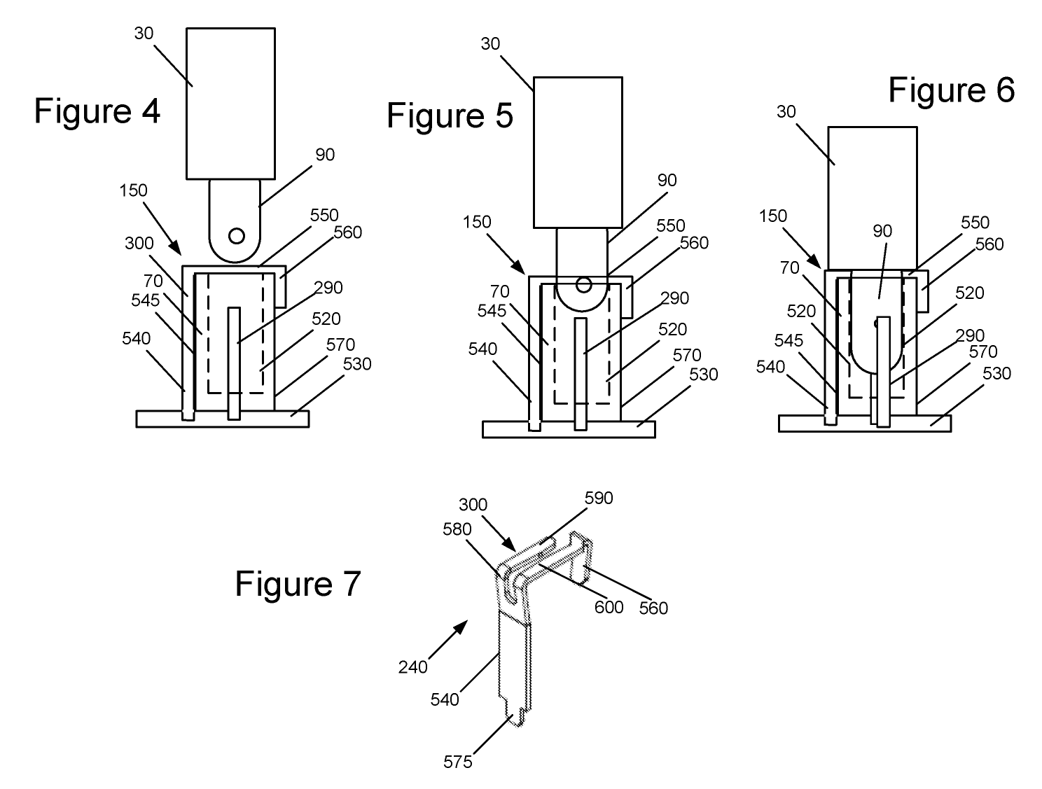

FIGS. 4-6 show one way a plug detection switch, shown generally at 150, may be disposed and operated at a socket of a receptacle. Here, only socket 70 of receptacle 40 is described. However, receptacle 50 may be similarly fitted with a plug detection switch.

As shown, the socket 70 includes a slot 520 in which a conductive fitting forming the second terminal 300 of the plug detection switch 150 is disposed.

The first terminal 290 of the plug detection switch 150 may be formed from a single piece of conductive material (e.g., copper). In this example, the first terminal 290 includes an elongated portion 540 extending from the printed circuit board 530. The elongated portion 540 extends from the printed circuit board 530 proximate to an exterior wall 545 of the socket 70, and terminates at a transverse portion 550. The transverse portion 550 extends from the elongated portion 540 across the opening of the slot 520. A tab 560 continues from the transverse portion 550 and proceeds to a position in which it is generally adjacent an exterior wall 570 of the socket 70.

The plug detection switch 150 may be held at the position shown in FIGS. 4-6 in a number of different manners. In one example, the elongated portion 540 and tab 560 are spaced from one another so that the first terminal 290 may securely engage the exterior walls 545 and 570 of the socket 70, while the elongated portion 540 is secured to the printed circuit board 530. This allows for press fitting of the plug detection switch 150 in its desired position. Additionally, or in the alternative, an adhesive may be used between one or more exterior surfaces of the socket 70 and one or more interior surfaces of the plug detection switch 150. Further securement techniques may also be used (e.g., mechanical fasteners, thermal fitting, etc.).

One way the plug detection switch 150 may operate is shown in the combination of FIGS. 4-6. In FIG. 4, the plug blade 90 of plug 30 is completely disengaged from physical contact with the first and second terminals 290, 300 of socket 70. In this state, the plug detection switch 150 is not active since it does not provide a conductive path between the first and second terminals 290, 300.

In FIG. 5, the blade 90 of plug 30 is only partially inserted in the slot 520. In this state, the blade 90 electrically contacts transverse portion 550 of the first terminal 290 but does not contact the second terminal 300. The plug detection switch 150 is still not active since the blade 90 does not provide an electrically conductive path between the first and second terminals 290, 300.

In FIG. 6, the blade 90 is completely inserted into the slot 520 so that it is in electrical contact with both the first and second terminals 290, 300. In this position, the blade 90 provides an electrically conductive path between the first and second terminals 290, 300 of the plug detection switch 150. This effectively actuates the plug detection switch 150 to pass the pulsed signal at the terminal 290 to the input of the high-frequency bypass filter 330.

FIG. 7 illustrates one way the first terminal 290 of FIGS. 4-6 may be constructed. In this example, the elongated portion 540 includes a first end having a conductive tab 575 configured for connection to the printed circuit board 530. A second end of the elongated portion 540 includes an elbow forming a transition section 580 between the elongated portion 540 and transverse portion 550. The transition section 580 is split so that the transverse portion 550 is formed as separate transverse arms 590, 600 that are generally parallel with one another. The spacing between the separate transverse arms 590, 600 is selected to allow insertion of the neutral blade 154 while concurrently facilitating engagement between one or both of the separate transverse arms 590, 600 and the terminal 290.

It will be appreciated that the foregoing disclosure provides examples of at least one system and technique. However, it is contemplated that other implementations of the system may differ in detail from the foregoing examples. All references in the disclosure are intended to reference particular examples and are not intended to imply any limitation as to the general scope of the disclosure.

1. An outlet for providing an alternating current voltage to a power plug, the outlet comprising:
a power receptacle configured to receive a plug blade of the power plug;
a switch having a first state when the plug blade is not present within the power receptacle, and a second state when the plug blade is present within the power receptacle, wherein the plug blade provides an electrically conductive path between terminals of the switch in the second state;
a pulse generator circuit configured to generate a pulsed signal having a frequency higher than a frequency of the alternating current voltage;
a pulse detection circuit; and
a feedback circuit configured to receive the pulsed signal from the pulse generator circuit, the feedback circuit providing an output signal to the pulse detection circuit, the output signal comprising a pulsed signal corresponding to the pulsed signal received from the pulse generator circuit when the switch is in the first state and a generally constant level signal when the switch is in the second state.

2. The outlet of claim 1, wherein the feedback circuit comprises a logic level converter circuit providing the pulsed signal to the pulse detection circuit.

3. The outlet of claim 2, where the logic level converter circuit comprises an optical coupler.

4. The outlet of claim 1, wherein the pulse generator circuit comprises a microcontroller coupled to an input of the feedback circuit, and wherein the feedback circuit comprises a logic level converter circuit configured to provide the pulsed signal to the pulse detection circuit.

5. The outlet of claim 1, wherein the pulse detection circuit comprises a microcontroller coupled to an output of the feedback circuit, and wherein the feedback circuit comprises a logic level converter circuit providing the pulsed signal to the pulse detection circuit.

6. The outlet of claim 5, wherein the microcontroller is configured to generate an interrupt using the output signal of the feedback circuit.

7. The outlet of claim 1, wherein the pulse detection circuit comprises a microcontroller coupled to an output of the feedback circuit, and wherein the microcontroller is configured to control execution of one or more smart outlet operations in response to a signal state with the output of the feedback circuit.

8. The outlet of claim 7, wherein the smart outlet operations include at least one of
providing the alternating current voltage to the power plug;
removing the alternating current voltage from the power plug;
measuring a current flow of the alternating current voltage to the power plug;
establishing a connection with a wireless network;
communicating with a wireless controller;
controlling operation of one or more further receptacles of the outlet; or
communicating with a wireless network.

9. The outlet of claim 1, wherein the switch goes to the second state only when the plug blade is completely inserted into the power receptacle.

10. The outlet of claim 1, wherein the pulse detection circuit comprises a microcontroller coupled to an output of the feedback circuit, the outlet further comprising a power relay circuit configured to connect the power plug to the alternating current voltage under control of the microcontroller.

11. The outlet of claim 1, wherein the switch comprises:
a first contact and a second contact, wherein the first and second contacts are electrically isolated from one another when the plug blade is not inserted into the power receptacle, and wherein the first and second contacts are electrically coupled through the plug blade when the plug blade is inserted into the power receptacle.

12. An outlet for providing an alternating current voltage to a power plug, the outlet comprising:
a power receptacle configured to receive a plug blade of the power plug, the power receptacle having a first contact and a second contact, wherein the first and second contacts are electrically isolated from one another when the plug blade is not inserted into the power receptacle, and wherein the first and second contacts are electrically coupled through the plug blade when the plug blade is inserted into the power receptacle;
a pulse generator circuit configured to provide a pulsed signal to an output thereof, wherein the pulsed signal has a frequency greater than a frequency of the alternating current voltage;
a pulse detection circuit configured to detect presence of a pulsed signal at an input thereof; and
a filter network configured to pass the pulsed signal from the output of the pulse generator circuit to the input of the pulse detection circuit when the first and second contacts are electrically isolated from one another, wherein the filter network is further configured to bypass the pulsed signal from the input of the pulse detection circuit when the first and second contacts are electrically connected to one another.

13. The outlet of claim 12, wherein the filter network comprises:
a high-pass filter electrically configured between the output of the pulse generator circuit and the input of the pulse detection circuit; and
a high-frequency bypass filter electrically configured between the second contact and the high-pass filter when the first and second contacts are electrically connected with one another.

14. The outlet of claim 12, wherein the filter network comprises a logic level converter circuit configured to provide the pulsed signal to the pulse generator circuit.

15. The outlet of claim 14, where the logic level converter circuit comprises one or more optical couplers.

16. The outlet of claim 14, wherein the pulse generator circuit comprises a microcontroller electrically coupled to an input of the filter network.

17. The outlet of claim 14, wherein the pulse detection circuit comprises a microcontroller electrically coupled to an output of the filter network.

18. The outlet of claim 12, wherein the pulse detection circuit comprises a microcontroller coupled to an output of the filter network, and wherein the microcontroller is configured to control execution of one or more smart outlet operations based on a state of the output of the filter network.

19. The outlet of claim 18, wherein the smart outlet operations include at least one of providing the alternating current voltage to the power plug;
removing the alternating current voltage from the power plug;
measuring a current flow of the alternating current voltage to the power plug;
establishing a connection with a wireless network;
communicate with a wireless controller;
controlling operation of one or more further receptacles of the outlet; or
communicating with a wireless network.

20. The outlet of claim 12, wherein the first and second contacts are electrically connected with one another only when the plug blade is completely inserted into the power receptacle.

21. An outlet for providing an alternating current voltage to a power plug, the outlet comprising:
a power receptacle configured to receive a plug blade of the power plug, the power receptacle having a first contact and a second contact, wherein the first and second contacts are displaced from one another so that the first and second contacts are electrically isolated from one another when the plug blade is not inserted into the power receptacle, and the first and second contacts are electrically connected by the plug blade when the plug blade is inserted into the power receptacle;
a microcontroller configured to generate a pulsed signal at an output thereof, wherein the microcontroller is further configured to detect a pulsed signal at an input thereof, the pulsed signal having a frequency greater than a frequency of the alternating current voltage; and
a feedback circuit, the feedback circuit including
a high-pass filter electrically configured between the output of the microcontroller and the second contact;
a high-frequency bypass filter electrically configured between the first contact and ground; and
a logic level converter circuit electrically coupled between the high-pass filter and the input of the microcontroller.

22. The outlet of claim 21, wherein the microcontroller is configured to control execution of one or more smart outlet operations based on whether pulsed signals are provided to the input of the microcontroller.

23. The outlet of claim 22, wherein the smart outlet operations include at least one of providing the alternating current voltage to the power plug;
removing the alternating current voltage from the power plug;
measuring a current flow of the alternating current voltage to the power plug;
establishing a connection with a wireless network;
communicate with a wireless controller;
controlling operation of one or more further receptacles of the outlet; or
communicating with a wireless network.
